(19) United States
(12) Patent Application Publication
(10) Pub. No.: US 2026/0031921 A1
(43) Pub. Date: Jan. 29, 2026

(54) METHOD, APPARATUS AND COMPUTER PROGRAM

(71) Applicant: Nokia Technologies Oy, Espoo (FI)

(72) Inventors: Alperen GUNDOGAN, Munich (DE); Ahmad MASRI, Tampere (FI); Janne ALI-TOLPPA, Espoo (FI); István Zsolt KOVÁCS, Aalborg (DK); Muhammad Majid BUTT, Naperville, IL (US); Sina KHATIBI, Munich (DE); Hans Thomas HÖHNE, Espoo (FI); Amaanat ALI, Espoo (FI); Teemu Mikael VEIJALAINEN, Espoo (FI); Keeth Saliya Jayasinghe LADDU, Espoo (FI); Jian SONG, Massy (FR)

(21) Appl. No.: 18/993,603

(22) PCT Filed: Jul. 11, 2023
(86) PCT No.: PCT/FI2023/050438

§ 371 Date: Jan. 13, 2025

(30) Foreign Application Priority Data
Jul. 13, 2022 (FI) 20225661

(51) Int. Cl. H04B 17/373; H04B 7/06; H04B 17/20

(52) U.S. Cl. CPC H04B 17/373; H04B 7/06966; H04B 17/252

(57) ABSTRACT

There is provided an apparatus comprising means for: receiving (700, 714), from a user equipment, measurement data relating to one or more cells of a network; determining (716), based on the measurement data, a prediction comprising at least one sequence of one or more beams that are predicted to have a highest signal quality for the user equipment at a respective one or more time instances; and sending (718), to the user equipment, the prediction.

### FIELD

The present application relates to a method, apparatus, system and computer program and in particular but not exclusively to predicting a sequence of beams for future use by a user equipment.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, from a user equipment, measurement data relating to one or more cells and/or one or more beams of a network; determining, based on the measurement data, a prediction comprising at least one sequence of one or more beams that are predicted to have a highest signal quality for the user equipment at a respective one or more time instances; and sending, to the user equipment, the prediction.

The means may be for: sending, to the user equipment, an indication that a beam sequence prediction is available for the user equipment, wherein the receiving is performed in response to sending the indication that the beam sequence prediction is available.

The prediction may comprise at least a first sequence of one or more beams that are the sequence of one or more beams that are predicted to have the highest signal quality for the user equipment at the respective one or more time instances, and a second sequence of one or more beams at the respective one or more time instances, wherein at least one of the one or more beams is different between the first sequence and the second sequence.

Sending the prediction may comprise sending at least one confidence interval associated with a respective sequence of the at least one sequence.

The confidence interval may be different for different time instances of a sequence.

Determining the prediction may be performed by a machine learning algorithm or an adaptive algorithm.

The means may be for: receiving, from the user equipment, an indication that the prediction was inaccurate for at least one of the one or more time instances.

The indication may comprise an indication that the prediction was inaccurate by more than the confidence interval.

The indication may comprise further measurement data for the one or more beams at one or more time instances where the prediction was inaccurate.

The means may be for: performing model retraining based on the indication.

The means may be for: determining a new prediction based at least in part on the indication; and sending the new prediction to the user equipment.

The means may be for: determining that the prediction was accurate.

Determining that the prediction was accurate may comprise at least one of: receiving, from the user equipment, an indication that the prediction was accurate; or receiving, from the user equipment, no indication that the prediction was inaccurate after a certain time.

Determining that the prediction was accurate may comprise determining that the prediction was accurate within the confidence interval.

The indication that the prediction was accurate may further comprise information about a sequence of one or more beams that the user equipment has utilised.

The means may be for: in response to determining that the prediction was accurate and based on the prediction, sending, to the user equipment, a signalling control element command to trigger beam or cell switch for the user equipment from a first beam at a time interval t to a second beam at time interval t+1.

According to an aspect, there is provided an apparatus comprising means for: sending, to a network node, measurement data relating to one or more cells and/or one or more beams of the network; and receiving, from the network node, a prediction comprising at least one sequence of one or more beams that are predicted to have a highest signal quality for the apparatus at a respective one or more time instances, wherein the prediction is based, at least in part, on the measurement data.

The means may be for: receiving, from the network node, an indication that a beam sequence prediction is available, wherein the sending is performed in response to receiving the indication that the beam sequence prediction is available.

The at least one sequence may comprise at least a first sequence of one or more beams that are the sequence of one or more beams that are predicted to have the highest signal quality for the user equipment at the respective one or more time instances and a second sequence of one or more beams, wherein at least one of the one or more beams is different between the first sequence and the second sequence.

Receiving the prediction may comprise receiving a confidence interval associated with a respective sequence of the at least one sequence.

The confidence interval may be different for different time instances of a sequence.

The means may be for: obtaining further measurement data for at least one of the one or more beams at least one of the respective one or more time instances; and determining whether the prediction was accurate based on a comparison between the further measurement data and the prediction.

The means may be for: in response to determining that the prediction was inaccurate for at least one of the one or more time instances, sending, to the network node, an indication that the prediction was inaccurate for at least one of the one or more time instances.

The indication may comprise an indication that the prediction was inaccurate by more than the confidence interval.

The indication may comprise the further measurement data for at least one of the one or more beams at one of the one or more time instances where the prediction was inaccurate.

The means may be for: receiving a new prediction from the network node, wherein the new prediction is based at least in part on the indication that the prediction was inaccurate.

The means may be for, in response to determining that the prediction was accurate: sending, to the network node, an indication that the prediction was accurate; or refraining from sending, to the network node, an indication that the prediction was inaccurate, wherein the network node is configured to assume that the prediction was accurate if the apparatus does not send the network node an indication that the prediction was inaccurate within a certain time.

Determining that the prediction was accurate may comprise determining that the prediction was accurate within the confidence interval.

The indication that the prediction was accurate may further comprise information about the trajectory the user equipment has followed.

The means may be for: receiving, from the network node, a signalling control element command to trigger beam switch from a first beam at a time interval t to a second beam at time interval t+1; and performing the beam switch based on the signalling control element command.

The means may be for: performing a beam switch from a first beam at a time interval t to a second beam at time interval t+1 based on the prediction if the prediction is accurate.

According to an aspect, there is provided an apparatus comprising at least one processor and at least one memory including a computer program code, the at least one memory and computer program code configured to, with the at least one processor, cause the apparatus at least to: receive, from a user equipment, measurement data relating to one or more cells and/or one or more beams of a network; determine, based on the measurement data, a prediction comprising at least one sequence of one or more beams that are predicted to have a highest signal quality for the user equipment at a respective one or more time instances; and send, to the user equipment, the prediction.

The at least one memory and at least one processor may be configured to cause the apparatus to: send, to the user equipment, an indication that a beam sequence prediction is available for the user equipment, wherein the at least one memory and at least one processor may be configured to cause the apparatus to receive the measurement data in response to sending the indication that the beam sequence prediction is available.

The prediction may comprise at least a first sequence of one or more beams that are the sequence of one or more beams that are predicted to have the highest signal quality for the user equipment at the respective one or more time instances, and a second sequence of one or more beams at the respective one or more time instances, wherein at least one of the one or more beams is different between the first sequence and the second sequence.

Sending the prediction may comprise sending at least one confidence interval associated with a respective sequence of the at least one sequence.

The confidence interval may be different for different time instances of a sequence.

Determining the prediction may be performed by a machine learning algorithm or an adaptive algorithm.

The at least one memory and at least one processor may be configured to cause the apparatus to: receive, from the user equipment, an indication that the prediction was inaccurate for at least one of the one or more time instances.

The indication may comprise an indication that the prediction was inaccurate by more than the confidence interval.

The indication may comprise further measurement data for the one or more beams at one or more time instances where the prediction was inaccurate.

The at least one memory and at least one processor may be configured to cause the apparatus to: perform model retraining based on the indication.

The at least one memory and at least one processor may be configured to cause the apparatus to: determine a new prediction based at least in part on the indication; and send the new prediction to the user equipment.

The at least one memory and at least one processor may be configured to cause the apparatus to: determine that the prediction was accurate.

The at least one memory and at least one processor may be configured to cause the apparatus to determine that the prediction was accurate by performing at least one of: receiving, from the user equipment, an indication that the prediction was accurate; or receiving, from the user equipment, no indication that the prediction was inaccurate after a certain time.

The at least one memory and at least one processor may be configured to cause the apparatus to determine that the prediction was accurate by determining that the prediction was accurate within the confidence interval.

The indication that the prediction was accurate may further comprise information about a sequence of one or more beams that the user equipment has utilised.

The at least one memory and at least one processor may be configured to cause the apparatus to: in response to determining that the prediction was accurate and based on the prediction, send, to the user equipment, a signalling control element command to trigger beam or cell switch for the user equipment from a first beam at a time interval t to a second beam at time interval t+1.

According to an aspect, there is provided an apparatus comprising at least one processor and at least one memory including a computer program code, the at least one memory and computer program code configured to, with the at least one processor, cause the apparatus at least to: send, to a network node, measurement data relating to one or more cells and/or one or more beams of the network; and receive, from the network node, a prediction comprising at least one sequence of one or more beams that are predicted to have a highest signal quality for the apparatus at a respective one or more time instances, wherein the prediction is based, at least in part, on the measurement data.

The at least one memory and at least one processor may be configured to cause the apparatus to: receive, from the network node, an indication that a beam sequence prediction is available, wherein the at least one memory and at least one processor may be configured to cause the apparatus to send the measurement data in response to receiving the indication that the beam sequence prediction is available.

The at least one sequence may comprise at least a first sequence of one or more beams that are the sequence of one or more beams that are predicted to have the highest signal quality for the user equipment at the respective one or more time instances and a second sequence of one or more beams, wherein at least one of the one or more beams is different between the first sequence and the second sequence.

The at least one memory and at least one processor may be configured to cause the apparatus to receive the prediction by receiving a confidence interval associated with a respective sequence of the at least one sequence.

The confidence interval may be different for different time instances of a sequence.

The at least one memory and at least one processor may be configured to cause the apparatus to: obtain further measurement data for at least one of the one or more beams at least one of the respective one or more time instances; and determine whether the prediction was accurate based on a comparison between the further measurement data and the prediction.

The at least one memory and at least one processor may be configured to cause the apparatus to: in response to determining that the prediction was inaccurate for at least one of the one or more time instances, send, to the network node, an indication that the prediction was inaccurate for at least one of the one or more time instances.

The indication may comprise an indication that the prediction was inaccurate by more than the confidence interval.

The indication may comprise the further measurement data for at least one of the one or more beams at one of the one or more time instances where the prediction was inaccurate.

The at least one memory and at least one processor may be configured to cause the apparatus to: receive a new prediction from the network node, wherein the new prediction is based at least in part on the indication that the prediction was inaccurate.

The at least one memory and at least one processor may be configured to cause the apparatus to, in response to determining that the prediction was accurate: send, to the network node, an indication that the prediction was accurate; or refrain from sending, to the network node, an indication that the prediction was inaccurate, wherein the network node is configured to assume that the prediction was accurate if the apparatus does not send the network node an indication that the prediction was inaccurate within a certain time.

The at least one memory and at least one processor may be configured to cause the apparatus to determine that the prediction was accurate by determining that the prediction was accurate within the confidence interval.

The indication that the prediction was accurate may further comprise information about the trajectory the user equipment has followed.

The at least one memory and at least one processor may be configured to cause the apparatus to receive, from the network node, a signalling control element command to trigger beam switch from a first beam at a time interval t to a second beam at time interval t+1; and perform the beam switch based on the signalling control element command.

The at least one memory and at least one processor may be configured to cause the apparatus to perform a beam switch from a first beam at a time interval t to a second beam at time interval t+1 based on the prediction if the prediction is accurate.

According to an aspect, there is provided a method comprising: receiving, from a user equipment, measurement data relating to one or more cells and/or one or more beams of a network; determining, based on the measurement data, a prediction comprising at least one sequence of one or more beams that are predicted to have a highest signal quality for the user equipment at a respective one or more time instances; and sending, to the user equipment, the prediction.

The method may comprise: sending, to the user equipment, an indication that a beam sequence prediction is available for the user equipment, wherein the receiving is performed in response to sending the indication that the beam sequence prediction is available.

The prediction may comprise at least a first sequence of one or more beams that are the sequence of one or more beams that are predicted to have the highest signal quality for the user equipment at the respective one or more time instances, and a second sequence of one or more beams at the respective one or more time instances, wherein at least one of the one or more beams is different between the first sequence and the second sequence.

Sending the prediction may comprise sending at least one confidence interval associated with a respective sequence of the at least one sequence.

The confidence interval may be different for different time instances of a sequence.

Determining the prediction may be performed by a machine learning algorithm or an adaptive algorithm.

The method may comprise: receiving, from the user equipment, an indication that the prediction was inaccurate for at least one of the one or more time instances.

The indication may comprise an indication that the prediction was inaccurate by more than the confidence interval.

The indication may comprise further measurement data for the one or more beams at one or more time instances where the prediction was inaccurate.

The method may comprise: performing model retraining based on the indication.

The method may comprise: determining a new prediction based at least in part on the indication; and sending the new prediction to the user equipment.

The method may comprise: determining that the prediction was accurate.

Determining that the prediction was accurate may comprise at least one of: receiving, from the user equipment, an indication that the prediction was accurate; or receiving, from the user equipment, no indication that the prediction was inaccurate after a certain time.

Determining that the prediction was accurate may comprise determining that the prediction was accurate within the confidence interval.

The indication that the prediction was accurate may further comprise information about a sequence of one or more beams that the user equipment has utilised.

The method may comprise: in response to determining that the prediction was accurate and based on the prediction, sending, to the user equipment, a signalling control element command to trigger beam or cell switch for the user equipment from a first beam at a time interval t to a second beam at time interval t+1.

According to an aspect, there is provided a method comprising: sending, to a network node, measurement data relating to one or more cells and/or one or more beams of the network; and receiving, from the network node, a prediction comprising at least one sequence of one or more beams that are predicted to have a highest signal quality for the apparatus at a respective one or more time instances, wherein the prediction is based, at least in part, on the measurement data.

The method may comprise: receiving, from the network node, an indication that a beam sequence prediction is available, wherein the sending is performed in response to receiving the indication that the beam sequence prediction is available.

The at least one sequence may comprise at least a first sequence of one or more beams that are the sequence of one or more beams that are predicted to have the highest signal quality for the user equipment at the respective one or more time instances and a second sequence of one or more beams, wherein at least one of the one or more beams is different between the first sequence and the second sequence.

Receiving the prediction may comprise receiving a confidence interval associated with a respective sequence of the at least one sequence.

The confidence interval may be different for different time instances of a sequence.

The method may comprise: obtaining further measurement data for at least one of the one or more beams at least one of the respective one or more time instances; and determining whether the prediction was accurate based on a comparison between the further measurement data and the prediction.

The method may comprise: in response to determining that the prediction was inaccurate for at least one of the one or more time instances, sending, to the network node, an indication that the prediction was inaccurate for at least one of the one or more time instances.

The indication may comprise an indication that the prediction was inaccurate by more than the confidence interval.

The indication may comprise the further measurement data for at least one of the one or more beams at one of the one or more time instances where the prediction was inaccurate.

The method may comprise: receiving a new prediction from the network node, wherein the new prediction is based at least in part on the indication that the prediction was inaccurate.

The method may comprise, in response to determining that the prediction was accurate: sending, to the network node, an indication that the prediction was accurate; or refraining from sending, to the network node, an indication that the prediction was inaccurate, wherein the network node is configured to assume that the prediction was accurate if the apparatus does not send the network node an indication that the prediction was inaccurate within a certain time.

Determining that the prediction was accurate may comprise determining that the prediction was accurate within the confidence interval.

The indication that the prediction was accurate may further comprise information about the trajectory the user equipment has followed.

The method may comprise: receiving, from the network node, a signalling control element command to trigger beam switch from a first beam at a time interval t to a second beam at time interval t+1; and performing the beam switch based on the signalling control element command.

The method may comprise: performing a beam switch from a first beam at a time interval t to a second beam at time interval t+1 based on the prediction if the prediction is accurate.

According to an aspect, there is provided a computer readable medium comprising program instructions for causing an apparatus to perform at least the following: receiving, from a user equipment, measurement data relating to one or more cells and/or one or more beams of a network; determining, based on the measurement data, a prediction comprising at least one sequence of one or more beams that are predicted to have a highest signal quality for the user equipment at a respective one or more time instances; and sending, to the user equipment, the prediction.

The program instructions may be for causing the apparatus to perform: sending, to the user equipment, an indication that a beam sequence prediction is available for the user equipment, wherein the receiving is performed in response to sending the indication that the beam sequence prediction is available.

The prediction may comprise at least a first sequence of one or more beams that are the sequence of one or more beams that are predicted to have the highest signal quality for the user equipment at the respective one or more time instances, and a second sequence of one or more beams at the respective one or more time instances, wherein at least one of the one or more beams is different between the first sequence and the second sequence.

Sending the prediction may comprise sending at least one confidence interval associated with a respective sequence of the at least one sequence.

The confidence interval may be different for different time instances of a sequence.

Determining the prediction may be performed by a machine learning algorithm or an adaptive algorithm.

The program instructions may be for causing the apparatus to perform: receiving, from the user equipment, an indication that the prediction was inaccurate for at least one of the one or more time instances.

The indication may comprise an indication that the prediction was inaccurate by more than the confidence interval.

The indication may comprise further measurement data for the one or more beams at one or more time instances where the prediction was inaccurate.

The program instructions may be for causing the apparatus to perform model retraining based on the indication.

The program instructions may be for causing the apparatus to perform: determining a new prediction based at least in part on the indication; and sending the new prediction to the user equipment.

The program instructions may be for causing the apparatus to perform: determining that the prediction was accurate.

Determining that the prediction was accurate may comprise at least one of: receiving, from the user equipment, an indication that the prediction was accurate; or receiving, from the user equipment, no indication that the prediction was inaccurate after a certain time.

Determining that the prediction was accurate may comprise determining that the prediction was accurate within the confidence interval.

The indication that the prediction was accurate may further comprise information about a sequence of one or more beams that the user equipment has utilised.

The program instructions may be for causing the apparatus to perform: in response to determining that the prediction was accurate and based on the prediction, sending, to the user equipment, a signalling control element command to trigger beam or cell switch for the user equipment from a first beam at a time interval t to a second beam at time interval t+1.

According to an aspect, there is provided a computer readable medium comprising program instructions for causing an apparatus to perform at least the following: sending, to a network node, measurement data relating to one or more cells and/or one or more beams of the network; and receiving, from the network node, a prediction comprising at least one sequence of one or more beams that are predicted to have a highest signal quality for the apparatus at a respective one or more time instances, wherein the prediction is based, at least in part, on the measurement data.

The program instructions may be for causing the apparatus to perform: receiving, from the network node, an indication that a beam sequence prediction is available, wherein the sending is performed in response to receiving the indication that the beam sequence prediction is available.

The at least one sequence may comprise at least a first sequence of one or more beams that are the sequence of one or more beams that are predicted to have the highest signal quality for the user equipment at the respective one or more time instances and a second sequence of one or more beams, wherein at least one of the one or more beams is different between the first sequence and the second sequence.

Receiving the prediction may comprise receiving a confidence interval associated with a respective sequence of the at least one sequence.

The confidence interval may be different for different time instances of a sequence.

The program instructions may be for causing the apparatus to perform: obtaining further measurement data for at least one of the one or more beams at least one of the respective one or more time instances; and determining whether the prediction was accurate based on a comparison between the further measurement data and the prediction.

The program instructions may be for causing the apparatus to perform: in response to determining that the prediction was inaccurate for at least one of the one or more time instances, sending, to the network node, an indication that the prediction was inaccurate for at least one of the one or more time instances.

The indication may comprise an indication that the prediction was inaccurate by more than the confidence interval.

The indication may comprise the further measurement data for at least one of the one or more beams at one of the one or more time instances where the prediction was inaccurate.

The program instructions may be for causing the apparatus to perform: receiving a new prediction from the network node, wherein the new prediction is based at least in part on the indication that the prediction was inaccurate.

The program instructions may be for causing the apparatus to perform, in response to determining that the prediction was accurate: sending, to the network node, an indication that the prediction was accurate; or refraining from sending, to the network node, an indication that the prediction was inaccurate, wherein the network node is configured to assume that the prediction was accurate if the apparatus does not send the network node an indication that the prediction was inaccurate within a certain time.

Determining that the prediction was accurate may comprise determining that the prediction was accurate within the confidence interval.

The indication that the prediction was accurate may further comprise information about the trajectory the user equipment has followed.

The program instructions may be for causing the apparatus to perform: receiving, from the network node, a signalling control element command to trigger beam switch from a first beam at a time interval t to a second beam at time interval t+1; and performing the beam switch based on the signalling control element command.

The program instructions may be for causing the apparatus to perform: performing a beam switch from a first beam at a time interval t to a second beam at time interval t+1 based on the prediction if the prediction is accurate.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example signalling diagram of L1/2 inter-cell mobility;

FIG. 5 shows an illustration of an example predictive mobility scenario;

FIG. 6 shows methods according to some examples;

FIGS. 7 to 9 show signalling exchanges according to some examples; and

FIG. 10 shows an example neural network architecture.

### DETAILED DESCRIPTION

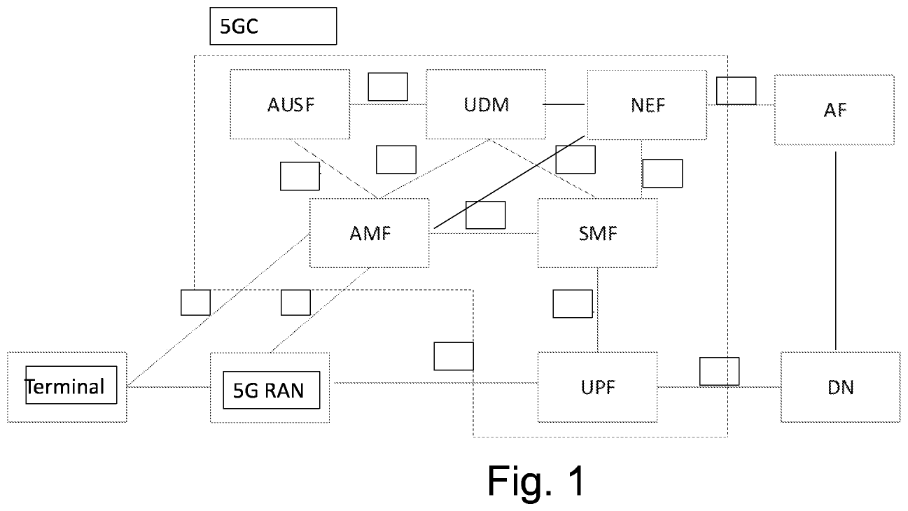

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions.

The 5GC may comprise the following entities: Network Slice Selection Function (NSSF); Network Exposure Function (NEF); Network Repository Function (NRF); Policy Control Function (PCF); Unified Data Management (UDM); Application Function (AF); Authentication Server Function (AUSF); an Access and Mobility Management Function (AMF); and Session Management Function (SMF).

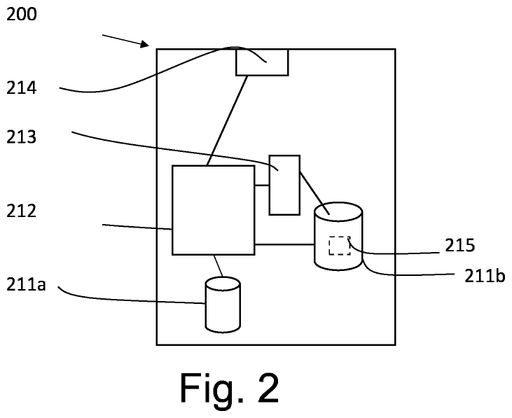

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

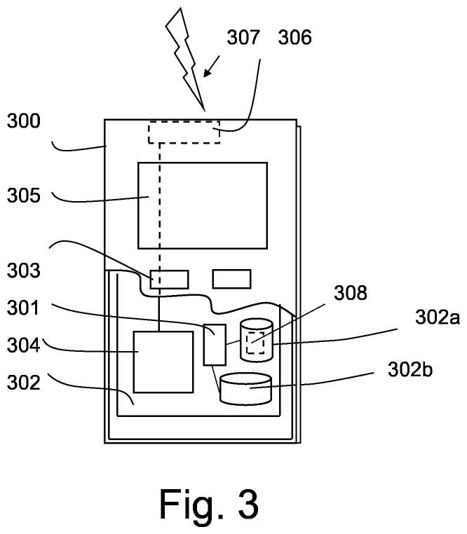

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

An objective in 3GPP is to provide mobility enhancement via L1/2 inter-cell mobility. In contrast to L3 mobility procedures where the handover between two cells is decided by RRC layer, L1/2 inter-cell mobility is configured by the Centralized Unit (CU) and performed/executed by the MAC layer terminated in a Distributed Unit (DU).

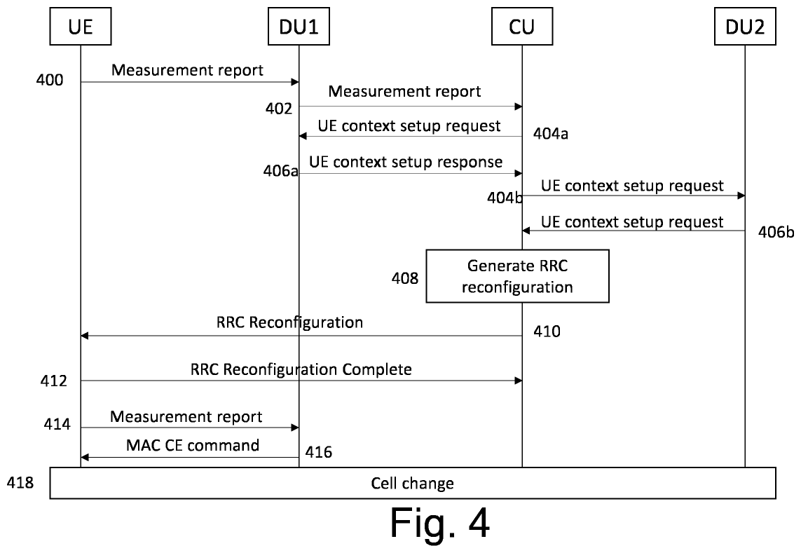

FIG. 4 shows an exemplary implementation for the signalling diagram of L1/2 inter-cell mobility from a serving cell in DU1 to a target cell in DU2, each DU being connected to a Central Unit (CU), a so called inter-DU intra-CU scenario. The same diagram may apply as well in case of intra-DU intra-CU cell change where DU1 would be the same as DU2, i.e. where handover is from a serving cell in DU1 to a target cell in DU1 (i.e. UE remains in the same DU).

At step 400, the UE sends a measurement report to DU1. At 402, DU1 forwards the measurement report to the CU. At 404a, the CU sends a UE context setup request to DU1, and at 404b to DU2. In response at 406a, DU1 sends a UE context setup response to the CU, and at 406b DU2 sends a UE context setup response to the CU.

At 408, the CU generates an RRC Reconfiguration message based on the measurement reporting for L1 cell change and comprising of a configuration of the prepared cell(s) in the target DU (i.e. DU2). At 410, the CU sends the RRC reconfiguration to the UE, which confirms that RRC reconfiguration is completed by sending an RRC Reconfiguration Complete message to the CU at 412.

Thus steps 400-412 may represent a preparation phase of L1/2 inter-cell mobility, where the network decides to configure the potential target cells (in DU2) for L1/2 inter-cell mobility based on the measurement report received from the UE.

After confirming the RRC Reconfiguration to the network in step 412, at 414 the UE starts to report periodically the L1 beam measurements of serving and candidate target cells.

Upon determining that there is a target candidate cell having a better radio link beam measurement than the serving cell, e.g., L1-RSRP of target beam measurement >L1-RSRP of serving beam measurement +Offset for e.g., Time-to-Trigger (TTT) time, at 416 the serving cell (i.e. DU1) sends a signalling Control Element (e.g. MAC CE) or a L1 message to trigger the cell change to the target candidate cell.

The handover from serving cell to target cell is executed by the UE in step 418.

One benefit of L1 inter-cell mobility compared to baseline handover and conditional handover is that the interruption during the handover execution as well as the execution time for the handover/cell change can be reduced substantially as the UE does not need to perform higher layer (RRC, PDCP) reconfiguration and for some scenarios UE connect to the target cell without using a Random Access Channel procedure.

3GPP TS 38.214 describes a NR beam measurement reporting framework. In particular, a channel state information (CSI) framework is defined, where the time and frequency resources that can be used by the UE to report CSI are controlled by the gNB. CSI may include Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP or L1-SINR. That is to say, the CSI may include L1 measurements.

CSI Reporting may be controlled using a CSI Reporting Configuration, where each Reporting setting CSI-ReportConfig may be associated with a single downlink BWP (indicated by higher layer parameter BWP-Id) given in an associated CSI-ResourceConfig for channel measurement. The CSI-ReportConfig may contain the parameter(s) for one CSI reporting band, such as: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator).

The time domain behavior of the CSI-ReportConfig may be indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset may apply in the numerology of the UL BWP in which the CSI report is configured to be transmitted on. The higher layer parameter reportQuantity may indicate the CSI-related, L1-RSRP-related or L1-SINR-related quantities to report.

Each CSI-ResourceConfig may contain a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting may be located in the DL BWP identified by the higher layer parameter BWP-id, and all CSI Resource Settings linked to a CSI Report Setting have the same DL BWP.

In the 3GPP Study Item “Study on Artificial Intelligence (AI)/Machine Learning (ML) for NR Air Interface”, several objectives were agreed.

These include use cases to focus on CSI feedback enhancement, e.g., overhead reduction, improved accuracy, prediction and beam management, e.g., beam prediction in time, and/or spatial domain for overhead and latency reduction, beam selection accuracy improvement.

Objectives relating to PHY layer aspects are also included, which include providing use case and UE and gNB collaboration level specific specification impact, such as new signalling (for example of AI/ML UE capabilities), signalling aspects for training and validation data assistance, assistance information, measurement, and feedback.

Another objective relates to Al/ML model, terminology and description to identify common and specific characteristics for framework investigations to identify various levels of collaboration between UE and gNB pertinent to the selected use cases, e.g various levels of UE/gNB collaboration targeting at separate or joint ML operation.

Mobility management is a scheme used in wireless communications to guarantee the service-continuity for a UE during UE mobility operations by minimizing the call drops, RLFs, unnecessary handovers, and ping-pong. In addition, for applications characterized with stringent QoS requirements such as reliability, latency etc., the QoE may be sensitive to the handover performance, so that mobility management should avoid unsuccessful handover and reduce the latency during handover procedure.

However, for some conventional methods, it may be challenging for a trial-and-error-based scheme to achieve nearly zero-failure handover.

A RAN study on enhancement for data collection for NR and EN-DC started in RAN3 #110e, with a general objective of studying the high level principles for the enablement of Al in RAN and the functional framework including the Al functionality and the inputs and outputs needed by an ML algorithm.

In one use case defined in TR 37.817 section 5.3 “Mobility Optimization” aims to increase the mobility performance of UEs by the use of Al/ML solutions. For example; the ML model located at the network can receive as input the radio measurements from the UE, predicted resource status of the neighbouring RAN nodes and UE trajectory prediction. Those inputs can be used to predict the handover target node in advance highly improving the chances of a successful handover of the UE.

UE trajectory prediction is discussed in 3GPP RAN3. These predictions may include the latitude, longitude, altitude, cell ID and beam ID of UE over a future period of time.

As discussed in previously, inter-cell mTRP transmission and L1-centric inter-cell mobility may rely on the L1 beam measurement report (i.e. CSI Measurement Report) of the serving and non-serving cells.

The UE can report both serving and non-serving cells as a part of the periodic L1 beam measurement reporting. Periodicity of reporting can be up to 5 ms, which in comparison to the minimum reporting periodicity of cell/beam quality reports for L3 mobility (120 ms), the network can collect the measurements from the UE much often.

However, L1 beam reporting increases the signalling overhead at the system as well as UE power consumption.

The signalling overhead on air interface caused by the L1 beam reporting may be mitigated with the help of trajectory predictions.

In the present disclosure, a UE trajectory refers to a UE's specific path/sequence through a radio network's cells and beams, that may be characterized by a PCI and SSB beam indices that may be further refined by CSI-RS based signals at the network.

Predicting the future trajectory of a UE could help in reducing the number of target cells that are required to report measurements.

However, it may be hard to perform accurate UE trajectory predictions for a single UE, although it may be possible to generate statistical predictions on UE trajectory based on the collected data (e.g, several beam IDs) through time.

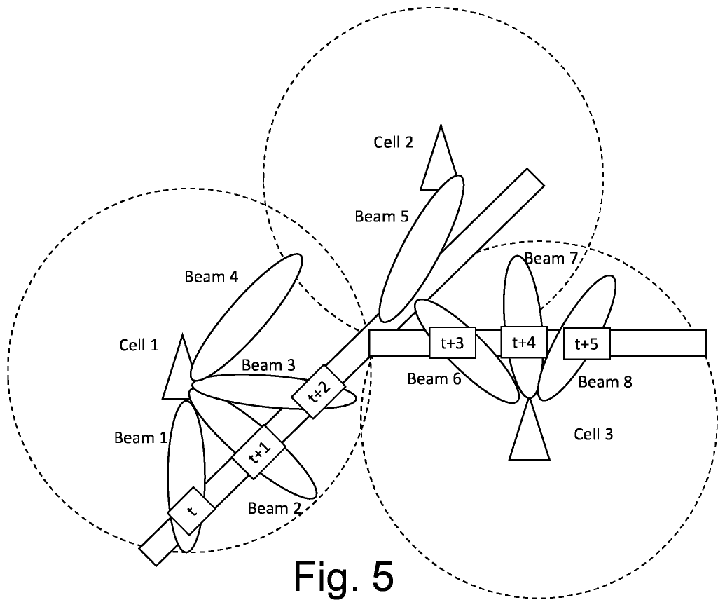

FIG. 5 presents an illustration of the problem where a mobile terminal moves on the street with an intersection point. The beam radiation pattern of each cell and the location of the UE for different time steps are shown in FIG. 5.

The problem is that wrong trajectory prediction at one time instance reduces the accuracy of the future predictions, as the prediction is handled in chain like fashion where current prediction results will assist in next future beam prediction.

For example from FIG. 5Error! Reference source not found., the network may predict the UEs on the street that have similar previous trajectories 90% of the time follow cell 2 after cell 1 (i.e. the UE moves straight on the road) and 10% of the time connects to cell 3 (i.e. the UE turns to the right at intersection point). Then, the network prediction of the best future beam indexes becomes [1, 2, 3, 4, 5, 5] at time-steps [t, t+1, t+2, t+3, t+4, t+5] respectively, which corresponds to the best beams for the predicted path of the UE continuing straight down the road.

However, as the UE turns to right path (as shown in FIG. 5), the best beam indexes would be [1, 2, 3, 6, 7, 8] at the different time-steps as shown in FIG. 5. As the prediction at time-step t+3 was wrong and the ML model uses the predictions at time t, t+1, t+2 and t+3 to perform prediction at time t+4, it is likely that the prediction at time t+4 will be wrong. Consequently, a reduced future predictions accuracy will result as we rely on the wrong prediction to make future predictions.

In summary, inter-cell lower layer mobility-based beam measurement may increase the signalling overhead at air interface and may require optimizing (reducing) without affecting beam selection error rate. While ML approaches based on UE trajectory predictions can be performed to reduce the signalling overhead, wrong predictions can lead to mobility failures (e.g. handover failure if the network tells UE to connect beam 5 of cell 2 at time t+4, however the signal quality of the cell 3, beam 7 is better as UE trajectory has changed according to the example in FIG. 5) and increasing service interruption time; and lead to additional signalling needed to handle the recovery of the connection.

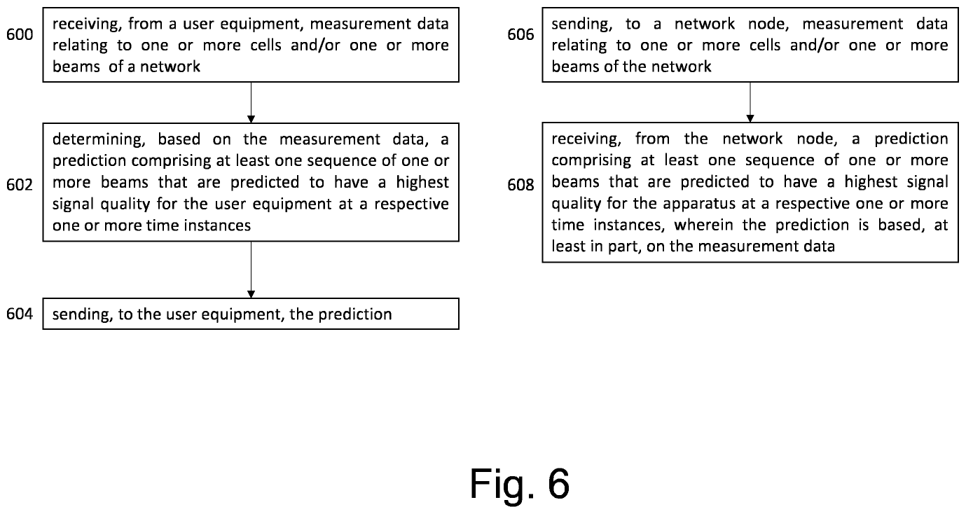

Reference is made to FIG. 6, which shows methods according to some examples.

At 600, a method comprises receiving, from a user equipment, measurement data relating to one or more cells and/or one or more beams of a network.

At 602, the method comprises determining, based on the measurement data, a prediction comprising at least one sequence of one or more beams that are predicted to have a highest signal quality for the user equipment at a respective one or more time instances.

At 604, the method comprises sending, to the user equipment, the prediction.

At 606, a method comprises sending, to a network node, measurement data relating to one or more cells and/or one or more beams of the network.

At 608, the method comprises receiving, from the network node, a prediction comprising at least one sequence of one or more beams that are predicted to have a highest signal quality for the apparatus at a respective one or more time instances, wherein the prediction is based, at least in part, on the measurement data.

Some examples may provide a solution that predicts the correct sequence of future beams while reducing signaling overhead without affecting beam selection error and mobility failure rate. Some examples utilise predictive inter-cell beam management methods to reduce CSI measurement overhead (L1 beam reporting) and avoid mobility failures by guaranteeing that the network is aware of the changes on UE trajectory within a certain confidence margin, e.g. mean square error threshold (scenario, deployment and configuration dependent).

In some examples, the network (e.g. DU for L1 mobility) may predict the best next N beam indexes/RSRP values in time, and share the prediction with the UE.

The prediction output may include the PCI of the cell and SSB-RS/CSI-RS indexes. The network may share a new prediction with the UE based on the received past measurements reports (e.g. CSI measurement reports) from the UE, and potentially other UEs identified/selected to be along the same UE trajectory or similar geographical movement paths (e.g. based on statistical distribution of the history data).

In some examples, the UE may evaluate the prediction received from the network and trigger CSI measurement reporting for L1 beam measurements if the prediction for the current time step does not match with the current measurement of the UE. In some examples, if the prediction for the current time step does match with the current measurement of the UE, no measurement report is sent.

Once the network receives the report from the UE, the network may correct the previous estimate for future beams based on the indication from the UE. The network may then perform inference to generate new predictions based on the measured data from the UE.

If the prediction of the network was correct, the beam change for the UE may be managed by the network with a signalling CE beam switching command in intra-cell beam management or signalling CE trigger handover message L1 inter-cell mobility. The beam change may be performed by the UE as long as the network prediction on best beam indexes/L1-RSRP measurements are correct.

The collected data at the network based on the wrong prediction may be used to facilitate the model update/retraining. Therefore, the network may store the updated measurement data for later model training. In some examples, the network can initiate the model update/retraining, for example if the network receives frequent wrong predictions the network may trigger the update/retraining.

In some examples, the network may share with the UE not only the best predicted trajectory in beam domain, but also the other possible trajectories for the UE (e.g. the most likely trajectories as determined based on other UE and historical data). For example; in FIG. 5, the network can share both predicted trajectory options [1, 2, 3, 4, 5, 5] and [1, 2, 3, 6, 7, 8] with the UE. In this case, UE may indicate to the network which predicted trajectory options it follows based on the real measurements.

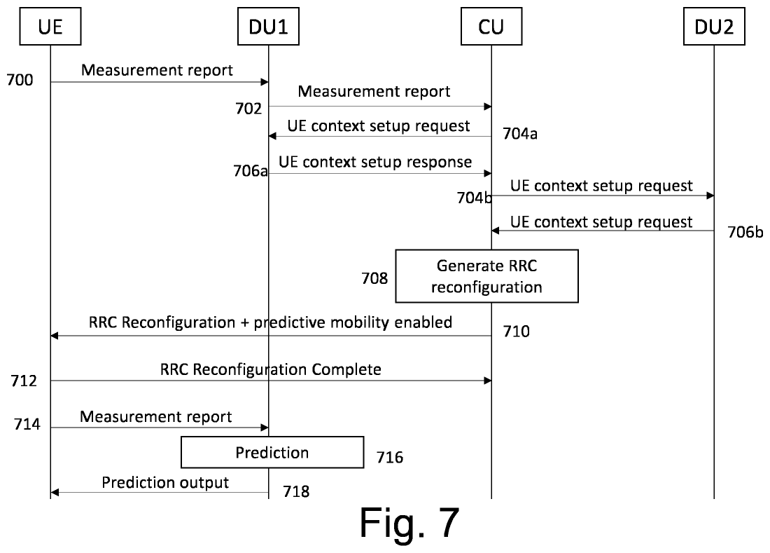

Reference is made to FIG. 7, which shows a signalling exchange according to some examples.

At 700, once the RRC measurement event is triggered, UE sends a measurement report including measurement results (e.g. L3 measurement results) to the serving cell under DU1.

At 702, DU1 forwards the measurements to the CU.

At 704, based on the measurement results, the CU may configure the cell(s) under DU1 and DU2. For example, the CU may send UE context setup request to DU1 at 704a and DU2 at 704b. This may be performed by CU to activate inter-cell beam management/L1 inter-cell mobility.

In some examples, the UE context setup request may include a request to learn the ML capabilities of the DU and whether it can perform predictive beam management/L1 mobility.

At 706a DU1, and at 706b DU2, send a UE context setup response to the CU. Optionally, the UE context setup response may include information indicating capabilities of the predictive beam management/L1 mobility if requested at 704a and 704b respectively.

In some examples, the information may include information about the required input data of the model, output type and prediction window (for example how many number of beams that can be predicted ahead of time).

At 708, based on the received predictive beam management/L1 mobility capabilities of the cells, CU generates the RRC reconfiguration and an indication that predictive mobility is enabled. The indication may be performed under CSI-ReportConfig IE.

At 710, the CU sends the RRC reconfiguration message together with the indication that predictive mobility is enabled, to the UE. The network may further include additional information for example, about synchronization points (or events) at which time the UE is forced to send a L1 measurement report to ensure it remains synchronized/aligned with the network with respect to the predicted and measured beams.

At 712, the UE sends RRC Reconfiguration Complete message to CU, indicating that the UE has received the RRC reconfiguration.

At 714, the UE starts to report N number of L1-RSRP measurement results of the serving and/or non-serving cell as indicated in the RRC-Reconfiguration. The measurement report may include for example beam measurements of the configured cells for inter-cell beam management/L1 inter-cell mobility. This may be used by the network (as a seed) for an initial prediction.

At 716, the serving cell under DU1 performs a prediction based on the collected data from the UE. The prediction may be for identifying a number of cells or beams that the UE is expected to move through (i.e. the predicted UE trajectory passes through the identified beams).

For example; at time-step t, the network predicts the best next 10 beams with granularity of 10 ms. The granularity of the prediction at each step can be also different which represents the predicted time of stay for each beam indexes (for example as the UE may not be moving with a uniform velocity across the predicted beams).

The prediction output may include the PCI of the cell and SSB-RS/CSI-RS indexes and/or RSRP values of each SSB-RS/CSI-RS. Further details of the ML model output are provided below.

At 718, the serving cell under DU1 sends the prediction output i.e. prediction of the next best beam indexes/RSRP values to the UE.

As a part of the prediction, the network may also send the confidence interval for the predictions. This may be used by UE to identify if the prediction of the network is within the tolerable margin based on the actual measurements.

For example; if the confidence interval for RSRP values prediction at time step t+2 is 1 dB, the UE may not trigger reporting if the predicted RSRP value of a beam index at t+2 is less than 1 dB different than the measured RSRP value of the same beam index at time t+2. Furthermore, the UE switches to those beams predicted (or proposed) by the network.

The following steps may depend on the accuracy of the prediction at the UE based on the comparison of the UE measurements and network prediction. Three different cases are considered:
Case 1: Wrong Prediction
Case 2: Correct prediction and network controlled mobility
Case 3: Correct prediction and UE controlled mobility

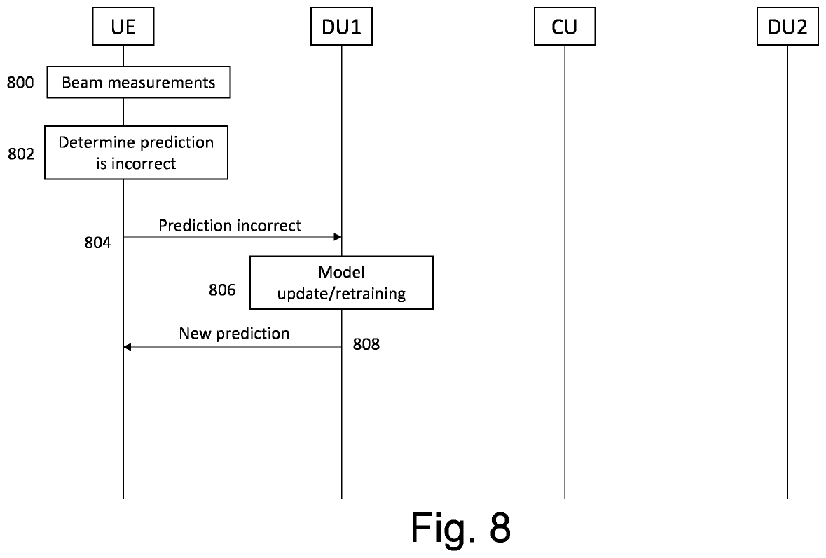

Reference is made to FIG. 8, which shows an example signalling exchange under case 1 above, i.e. in the case where the prediction is incorrect. The signalling exchange of FIG. 8 may follow on after step 718 described in relation to FIG. 7 above.

At 800, the UE performs one or more beam measurements. The UE may not report the beam measurements of the configured cells as long as the network prediction matches with the actual measurement.

The UE may continue to perform measurements of the serving and non-serving cells but as long as the actual measurements match with the network prediction, UE may not include L1 beam measurements.

If the network predicts the best future beam indexes, L1 reporting may be triggered if the predicted best beam index at time t+X is not equal to the measured best beam index at time t+X.

For example, referring to the example of FIG. 5, the network may predict the best beam predicted indexes as [1, 2, 3, 4, 5, 5]. The UE may trigger a report at time t+3 as the measured best beam belongs to cell 3 and beam 6 (not cell 2 and beam 4) to indicate the predicted beam was wrong and includes the actual measurements in a report.

In some examples, if the network predicts the best beam measurement values (e.g. L1-RSRP), L1 reporting is triggered if the measured beam measurement value is not in the confidence interval of the network prediction (as signalled from the network when the measurement configuration parameters have been provided).

The network can share the confidence interval e.g. 95% with the predictions. The confidence interval can be different for each beam prediction depending on the statistics of the collected data at the network for a specific beam.

In some examples, the UE can still send CSI reports that includes the KPIs e.g. CQI, PMI, RI, etc. if it does not receive any prediction from the network about those KPIs.

At 802, the UE determines that there is a mismatch between the network prediction and actual measurement, based on the previously received prediction and the measurements obtained at 800.

At 804, the UE sends an indication that the prediction was incorrect to the network. The indication may include an actual measurement performed by the UE indicating that the prediction of the network at time step e.g. t+T was wrong.

In some examples, the indication may be sent when the mismatch between the network prediction and the actual measurement is greater than the confidence interval of the prediction.

In some examples, in the case where the network performs prediction of the signal quality values, the UE may share the mismatch has occurred between [t−N, t] e.g. t_err. This may indicate to the network how much it needs to adjust its prediction in order to obtain more accurate measurement data. In some examples, if the t_err is within the confidence interval of the prediction, then the UE may ignore the difference—i.e. the UE does not send the indication at 804.

In some examples where the network performs prediction of the signal quality values, the UE can keep a history of each beam measurement equal to N e.g. 10 past training frames length. If this signal quality prediction of the beam is wrong, then the UE may share the beam measurements of the history between [t−N, t] where the t is the current time step.

At 806, the network, based on the indication received from the UE at 804, may perform model updating/retraining. That is to say, the network may take actions to improve its ML model as a response to wrong prediction feedback. In some examples, the network may store the indication, optionally including the measurement data, for later model training.

In some examples, the network may initiate the model update (for example switch to another model)/retraining if it receives often consecutive wrong predictions, for example more than a certain number of indications, or more than a certain number of indications in a certain time period.

At 808, the network shares a new prediction with the UE based on the received measurements.

In some examples, the DU may also indicate a beam switch as a part of the new prediction if the UE measurements indicate a beam switch. For example; the network may predict that UE observes [1, 2, 2, 2, 2] as a best beam indexes but if the actual UE measurements indicates that [1, 2, 2, 3, 3] as a best beam sequences observed by the UE, the network may send a new prediction to UE including a beam switch to a beam 3.

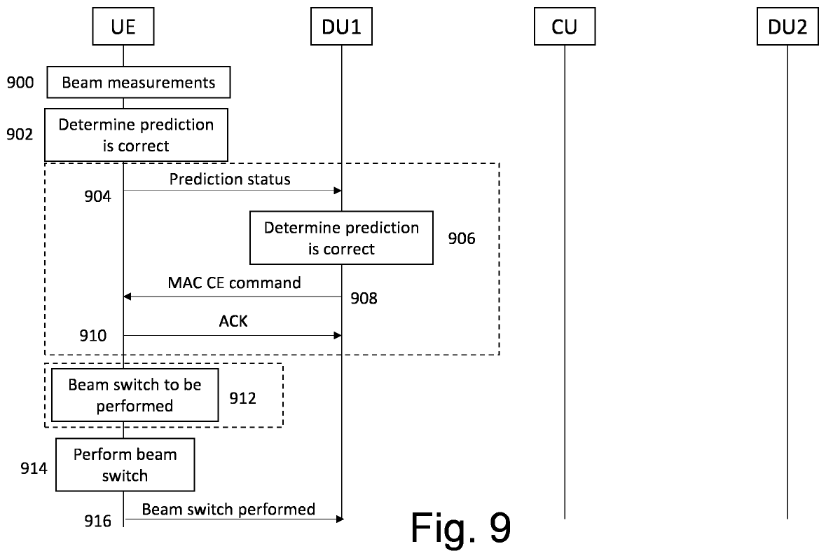

Reference is made to FIG. 9, which shows an example signalling exchange under case 2 or 3 above, i.e. in the case where the prediction is correct. The signalling exchange of FIG. 9 may follow on after step 718 described in relation to FIG. 7 above.

Steps 900 to 908 correspond to case 2 described previously, where the network's prediction is correct and mobility is controlled by the network. It should be understood that, in some examples where steps 900 to 908 are performed, steps 910 to 912 may not be performed.

At 900, the UE performs one or more beam measurements, and at 902, based on the measurements, determines that the prediction was correct. For example, the network might predict that at a particular time, such as time t+40 ms (t is the time-step of the prediction), the UE will observe a particular beam, such as SSB-RS index 5 of the PCI 2, as strongest beam measurement. Based on the prediction, the UE performs a beam measurement at the particular time, such as time step t+40 ms, and measures that the particular beam, such as SSB-RS index 5 of PCI 2, is the strongest beam index, thereby verifying the prediction.

Optionally, at 904, the UE may send an indication about the status of the prediction. For example, the UE may send an indication of the prediction was correct or not.

In some examples, a 1 bit indication may be used to indicate that the network prediction was accurate. This may allow the network to trigger the beam switching based on the prediction.

In some examples, if the prediction of the network is still within the confidence interval, the UE may send information about the mismatch between the prediction of the network and the measurements of the UE.

If multiple trajectories are shared with the UE, the UE may also include information about trajectory it follows along with the indication.

At 906, the network determines that the prediction was correct.

For example, the network may receive the indication (e.g. 1 bit indication, an indication with the length of k bit, where k>=1, an indication providing at least 2 different values referring to correct or wrong prediction, an indication which provides a likelihood p that UE is still on path as predicted, where likelihood p>=thres1 indicates correct predicted path, thres2 indicates wrong predicted path) stating that the prediction was correct at 904. Alternatively, if the UE is configured to report L1-RSRP beam measurements only if the prediction is wrong, the network may assume that the prediction at the time step e.g. t+40 ms was correct, provided that the UE has not indicated that it was wrong at time step t+40 ms.

At 908, the serving cell sends a signalling CE (e.g. MAC CE) command to the UE to trigger the beam/cell switch.

In some examples, the signalling CE command is sent when the network determines that the prediction at time step t is not equal to the prediction at time step t+1 (t!=t+1) i.e. there is a beam switching event that the network determines.

At 910, the UE acknowledges the beam switch.

In some examples, the UE may decline the beam switch if the measurement at time t+X does not match with the prediction at time t+X, and the UE may inform the network with an actual measurement on the current beam.

Step 912 corresponds to case 3 described previously, where the network's prediction is correct and mobility is controlled by the UE. It should be understood that, in some examples where step 912 is performed, steps 900 to 910 may not be performed.

At 912, a beam switch/change is determined by the UE based on the prediction received from the network. That is to say, the beam switch may be determined by the UE without receiving signalling CE message from the network for execution. In some examples, the UE may determine that a beam switch is to be performed in response to determining that the actual beam measurement matches with the network prediction.

At 914, the UE performs a beam switch operation, either in response to receiving the signalling CE command at 908, or in response to the UE determining that the beam switch is to be performed at 912.

For example, the UE may determine whether the predicted beam at time step t+1 belongs to the beam of the prepared/target cell. When the UE determines that the predicted beam at time step t+1 belongs to the beam of the prepared/target cell, the UE may perform a random access procedure to access the target beam of the prepared/target cell completing the beam switch.

At 916, the UE indicates to the network that a successful beam switch operation has been performed. The UE may use the L1/L2 ACK on the uplink of the new beam after successfully decoding the PDCCH on the previous serving beam to provide the indication.

As mentioned previously, in some examples the network may also share different trajectories with the UE. For instance, the network may share a trajectory as a sequence of beam IDs, and thus two trajectories may be indicated as two sequences of beam IDs (for example a first trajectory as [1, 2, 3, 4, 5, 5] and a second trajectory as [1, 2, 3, 6, 7, 8]).

In some examples, the beams and cells which are indicated in the trajectories may be prepared by the network. That is, the network expects that the UE will connect to the beams as specified by the trajectory.

In some examples, as long as the UE follows a trajectory contained in the trajectory list, the UE will not send reports about its serving or neighbour beam measurements to the network. The UE may however provide channel state information to the network, such as beam precoding information, as needed.

In some examples, the UE may switch to new beams according to the trajectory using means as described previously. For example, the network may provide at predicted times a signalling CE, or the UE may indicate when the switching time is at hand by an indicator.

If the UE wishes to choose a cell/beam which is not in the trajectory list, the UE may begin sending full neighbour beam/cell measurement reports.

In some examples, the network may indicate a ranking in its list of trajectories. The ranking may indicate that a first trajectory in the list has prepared cells, but the cells in other trajectories are not prepared. When the UE determines that it is not going to follow the first trajectory, the UE may indicate to the network the corresponding index of the trajectory list that it will follow.

For instance, in the given example of a first trajectory as [1, 2, 3, 4, 5, 5] and a second trajectory as [1, 2, 3, 6, 7, 8], both trajectories have the first three beams [1, 2, 3,] in common. Once the UE realizes that after beam/cell 3 it will not go to 4, but to 6, the UE indicates to the network that the UE is “choosing trajectory 2”. In response to receiving the indication, the network may prepare cells/beams along the second trajectory for the UE and send an indication to the UE that the cells/beams along trajectory 2 are prepared. After having received the confirmation from the network the UE may assume that cells in path 2 are prepared.

In some examples, a ML model may not be needed. The network may obtain the list of trajectories by collecting serving cell/beam sequences from past UEs, and rank them according to their frequency of occurrence (e.g. which beams are followed after UE is connected to beam A).

In some examples, an inter-cell HO may be organized also by way of preconfigured RACH grant. Then the network may not need to send a signalling CE to trigger the UE's change, but the UE initiates the HO (e.g. case 3).

As explained above, in some examples, a ML framework may be utilised to predict UE trajectories and identify a number of cells or beams that the UE is expected to move through. That is to say, a ML model at the network may be used to perform prediction of the best beam indexes and cell ids of a given UE that is connect to the cell.

For example; the model can generate an output of the predicted best SSB-RS indexes and Physical Cell Ids (PCIs) for a UE based at time step t based on the past measurements. In some examples, a Long Short-Term Memory (LSTM) network can be applied to predict the future from sequences of variable lengths. LSTM networks may be preferred for time-series prediction due to the capabilities of learning long-term relations in data, and may solve issues relating to the vanishing gradient problem in RNN by introducing special gates (e.g. forget gate, input gate).

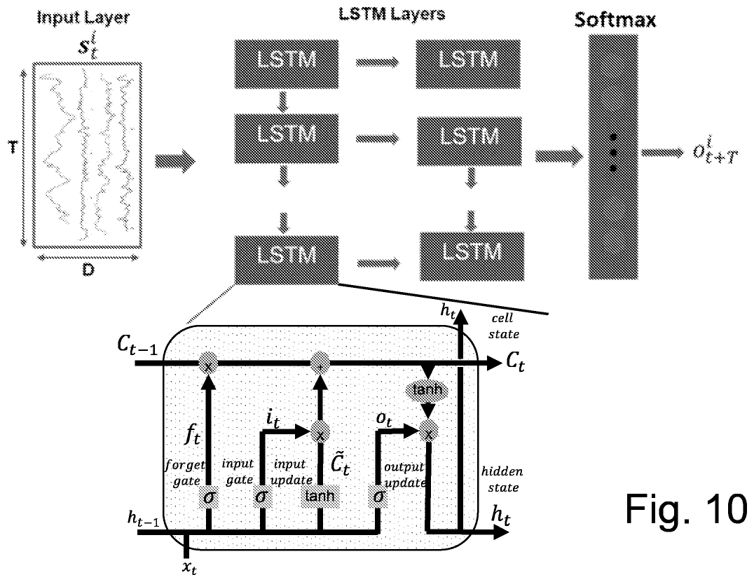

An example of a neural network architecture of a model is show in FIG. 10.

The input matrix

$${s}_{t}^{i} = [ {x}_{t - T}^{i} , {x}_{t - T + 1}^{i} , … {x}_{t}^{i} ] ,$$

comprises D features i.e.

$$D = \vert {x}_{t}^{i} \vert$$

(e.g. Input types) over the time of T in past where t is the time of the prediction and i is the UE id (for example C-RNTI).

The size of the input matrix may depend on the granularity of the input-for example 100 ms in time over T e.g. 1 sec may result in 10 stacked input feature D, and the number of the features i.e. D.

In FIG. 10, there are two LSTM layers followed by a softmax output layer. It should be understood that in other examples, a different configuration may be used. Each LSTM cell may receive the input xₜ as an input and generates a cell state

$${C}_{t}^{i}$$

and outputs a hidden state value

$${h}_{t}^{i}$$

which may be used for anowner LSTM cell.

Sigmoid activation function σ can be used for input/forget/output gates of the LSTM cell. The output value of the sigmoid function may be within the range of 0 and 1. tanh activation may be used for cell states cₜ and hidden states hₜ and may generate an output value within the range of −1 to 1. The output layer may use a softmax or sigmoid activation function to calculate the probabilities of each label e.g. the probability of a beam/cell to be the best beam/cell at time t+T.

The input data of the model may comprise the following information;
UE measurement reports, for example RSRP, RSRQ or SINR measurements;
Correct predictions from the previous time steps;
UE velocity information (e.g calculated based on observed doppler shift)
UE location information (optional, if available); and
Current/predicted resource of the serving cell and the neighbouring cells (optional, if available).

The UE measurement reports may help the network to understand the channel degradation through time and can be used for initial prediction. As long as the model prediction is correct (verified by the UE), the network may not need the use/transmission/consideration/evaluation of UE measurement reports.

The correct predictions may include the best beam indexes and PCIs. The network may use the earlier predictions as a ground truth to predict the future, as long as the model prediction is verified as being correct according to information provided by the UE.

The UE location information may include coordinates of the UE and velocity.

The current/predicted resource of the serving and neighbouring cells may be used by the model to understand the traffic load information on different beams/cells which can affect the inter-cell/beam interference and also the best beam indexes/RSRPs observed by the UE.

The model may be capable of performing multi-step prediction. That is to say, the model may use the prediction at the previous step can as an input for future predictions.

Based on the input data, the model may perform at least the following types of prediction:
Prediction of the best beam indexes and PCIs of the given UE; and
Prediction of the RSRP values of configured reference signal indexes of the cells.

To predict the best beam indexes and PCU, the ML model may generate an output vector for the prediction at time

$$t + T {o}_{t + T}^{i} = [ {SSB}_{t + T}^{i} , {PCI}_{t + T}^{i} ] where {SSB}_{t + T}^{i}$$

is the best SSB-RS index and

$${PCI}_{t + T}^{i}$$

is the physical cell id of UE i at time t+T. Note that,

$${SSB}_{t + T}^{i}$$

is related to the

$${PCI}_{t + T}^{i}$$

e.g. it is the beam of the PCI. In case of multi-step prediction, the output may be a matrix

$${o}_{t + T}^{i} = [ {o}_{t + g}^{i} , {o}_{t + 2 g}^{i} , … , {o}_{t + Ng}^{i} ]$$

where g is the granularity of the prediction (e.g. 100 ms), and Ng=T. So, if the T is 1000 ms and g is the 100 ms, the ML model may generate 10 predictions which shows that the best beam/cell pairs for the UE i.

To predict the RSRP values, the ML model may generate an output vector

$${o}_{t + T}^{i , c} = [ {SSB}_{m e a {s}_{t + T}}^{i , c , 0} , {SSB}_{{meas}_{t + T}}^{i , c , 1} , … , {SSB\_meas}_{t + T}^{i , c , K} ] where {o}_{t + T}^{i , c}$$

is the prection of RSRP values of the SSB-RS beam indexes at t+T for the cell id c.

$${SSB\_meas}_{t + T}^{i , c , 0}$$

is the estimated RSRP measurement of the SSB-RS index 0 of the cell c observed by UE i at the time step t+T. In case of multi-step prediction, the output may be a matrix as

$${o}_{t + T}^{i , c} = [ {o}_{t + g}^{i , c} , {o}_{t + 2 g}^{i , c} , … , {o}_{t + Ng}^{i , c} ]$$

where g is the granularity of the prediction e.g. 100 ms, and Ng=T.

For the model training, the input data stated above and the UE feedback may be logged over time and collected in the network entity that performs the training. As beam management including both intra and inter-cell beam management may be handled by the gNB or by the gNB-Distributed Unit, and the inference may also be performed at the gNb or gNB-DU.

As an example use case, we may assuming the scenario in FIG. 5, where cell 1 performs prediction of the best beam indexes of the UE at time step t as {t:1, t+1:2, t+2:3, t+3:4, t+4:5, t+5:5}.

The UE moves along the street and continues to perform measurements of the serving and non-serving cells, but the UE does not initiate reporting as long as the prediction is correct.

At time step t+3, the UE turns right on the street and measures the beam id 6 from the cell 3 as the strongest beam. The UE compares the actual measurement with the network prediction at time step t+3 which indicates the beam id 4.

As the prediction of the network is wrong, the UE indicate the wrong prediction to the network together with the other beam measurements at time step t+3. Based on the received correct measurements at time step t+3, the network updates the prediction considering the trajectory of the UE e.g. {t: 1, t+1:2, t+2:3, t+3:6} and predict the next beam indexes at t+4 as 7, t+5 as 8 and informs UEs with the new prediction.

Thus, in some examples, an adaptive inter-cell beam management procedure with reduced CSI measurement overhead is provided. The network can collect feedback about its prediction (receive ground truth from the UE) and retrain the model. A network driven ML approach may be utilised, which may mean that no UE ML capabilities are needed to be implemented. For multi-step predictions, the network may use only the correct past predictions as an input for the next predictions, and with the previously described methods the network may avoid wrong sequential predictions which can lead to mobility failures and high interruption time.

In some examples, there is provided an apparatus comprising means for receiving, from a user equipment, measurement data relating to one or more cells and/or one or more beams of a network; determining, based on the measurement data, a prediction comprising at least one sequence of one or more beams that are predicted to have a highest signal quality for the user equipment at a respective one or more time instances; and sending, to the user equipment, the prediction.

In some examples, the apparatus may comprise at least one processor and at least one memory including a computer program code, the at least one memory and computer program code configured to, with the at least one processor, cause the apparatus at least to: receive, from a user equipment, measurement data relating to one or more cells and/or one or more beams of a network; determine, based on the measurement data, a prediction comprising at least one sequence of one or more beams that are predicted to have a highest signal quality for the user equipment at a respective one or more time instances; and send, to the user equipment, the prediction.

In some examples, there is provided an apparatus comprising means for: sending, to a network node, measurement data relating to one or more cells and/or one or more beams of the network; and receiving, from the network node, a prediction comprising at least one sequence of one or more beams that are predicted to have a highest signal quality for the apparatus at a respective one or more time instances, wherein the prediction is based, at least in part, on the measurement data.

In some examples, the apparatus may comprise at least one processor and at least one memory including a computer program code, the at least one memory and computer program code configured to, with the at least one processor, cause the apparatus at least to: send, to a network node, measurement data relating to one or more cells and/or one or more beams of the network; and receive, from the network node, a prediction comprising at least one sequence of one or more beams that are predicted to have a highest signal quality for the apparatus at a respective one or more time instances, wherein the prediction is based, at least in part, on the measurement data.

It should be understood that the apparatuses may comprise or be coupled to other units or modules etc., such as radio parts or radio heads, used in or for transmission and/or reception.

Although the apparatuses have been described as one entity, different modules and memory may be implemented in one or more physical or logical entities.

It is noted that whilst some embodiments have been described in relation to 5G networks, similar principles can be applied in relation to other networks and communication systems.

Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-16. (canceled)

17. An apparatus comprising at least one processor and at least one memory including a computer program code, the at least one memory and computer program code configured to, with the at least one processor, cause the apparatus at least to:
receive, from a user equipment, measurement data relating to one or more cells and/or one or more beams of a network;
determine, based on the measurement data, a prediction comprising at least one sequence of one or more beams that are predicted to have a highest signal quality for the user equipment at a respective one or more time instances; and
send, to the user equipment, the prediction.

18. The apparatus of claim 17, wherein the prediction comprises at least a first sequence of one or more beams that are the sequence of one or more beams that are predicted to have the highest signal quality for the user equipment at the respective one or more time instances, and a second sequence of one or more beams at the respective one or more time instances, wherein at least one of the one or more beams is different between the first sequence and the second sequence.

19. The apparatus of claim 17, further being caused to:
receive, from the user equipment, an indication that the prediction was inaccurate for at least one of the one or more time instances.

20. The apparatus of claim 17, further being caused to:
receive, from the user equipment, an indication that the prediction was inaccurate for at least one of the one or more time instances, and
perform model retraining based on the indication.

21. The apparatus of claim 17, further being caused to:
receive, from the user equipment, an indication that the prediction was inaccurate for at least one of the one or more time instances,
determine a new prediction based at least in part on the indication; and
send the new prediction to the user equipment.

22. The apparatus of claim 17, further being caused to:
determine that the prediction was accurate.

23. The apparatus of claim 17, further being caused to:
determine that the prediction was accurate, wherein the determining that the prediction was accurate comprises at least one of:
receiving, from the user equipment, an indication that the prediction was accurate; or receiving, from the user equipment, no indication that the prediction was inaccurate after a certain time.

24. The apparatus claim 17, further being caused to:
determine that the prediction was accurate, wherein the determining that the prediction was accurate comprises at least one of:
receiving, from the user equipment, an indication that the prediction was accurate; or receiving, from the user equipment, no indication that the prediction was inaccurate after a certain time, and
wherein the indication that the prediction was accurate further comprises information about a sequence of one or more beams that the user equipment has utilised.

25. The apparatus of any of claim 17, further being caused to:
determine that the prediction was accurate, and to:
, based on the prediction, send, to the user equipment, a signalling control element command to trigger beam or cell switch for the user equipment from a first beam at a time interval t to a second beam at time interval t+1.

26. An apparatus comprising at least one processor and at least one memory including a computer program code, the at least one memory and computer program code configured to, with the at least one processor, cause the apparatus at least to:
send, to a network node, measurement data relating to one or more cells and/or one or more beams of the network; and
receive, from the network node, a prediction comprising at least one sequence of one or more beams that are predicted to have a highest signal quality for the apparatus at a respective one or more time instances, wherein the prediction is based, at least in part, on the measurement data.

27. The apparatus of claim 26, wherein the at least one sequence comprises at least a first sequence of one or more beams that are the sequence of one or more beams that are predicted to have the highest signal quality for the user equipment at the respective one or more time instances and a second sequence of one or more beams, wherein at least one of the one or more beams is different between the first sequence and the second sequence.

28. The apparatus of claim 26, further being caused to obtain further measurement data for at least one of the one or more beams at least one of the respective one or more time instances; and
determine whether the prediction was accurate based on a comparison between the further measurement data and the prediction.

29. The apparatus of claim 26, further being caused to:
obtain further measurement data for at least one of the one or more beams at least one of the respective one or more time instances;
determine whether the prediction was accurate based on a comparison between the further measurement data and the prediction, and
in response to determining that the prediction was inaccurate for at least one of the one or more time instances, send, to the network node, an indication that the prediction was inaccurate for at least one of the one or more time instances.

30. The apparatus of claim 26, further being caused to:
obtain further measurement data for at least one of the one or more beams at least one of the respective one or more time instances;
determine whether the prediction was accurate based on a comparison between the further measurement data and the prediction, and,
in response to determining that the prediction was accurate,
send, to the network node, an indication that the prediction was accurate; or
refrain from sending, to the network node, an indication that the prediction was inaccurate, wherein the network node is configured to assume that the prediction was accurate if the apparatus does not send the network node an indication that the prediction was inaccurate within a certain time.

31. The apparatus of claim 26, further being caused to:
obtain further measurement data for at least one of the one or more beams at least one of the respective one or more time instances;
determine whether the prediction was accurate based on a comparison between the further measurement data and the prediction;
in response to determining that the prediction was accurate,
send to the network node, an indication that the prediction was accurate, or
refrain from sending, to the network node, an indication that the prediction was inaccurate, wherein the network node is configured to assume that the prediction was accurate if the apparatus does not send the network node an indication that the prediction was inaccurate within a certain time;
receive, from the network node, a signalling control element command to trigger beam switch from a first beam at a time interval t to a second beam at time interval t+1; and
perform the beam switch based on the signalling control element command.

32. The apparatus of claim 26, further being caused to:
obtain further measurement data for at least one of the one or more beams at least one of the respective one or more time instances;
determine whether the prediction was accurate based on a comparison between the further measurement data and the prediction;
in response to determining that the prediction was accurate, send to the network node, an indication that the prediction was accurate, or
refrain from sending, to the network node, an indication that the prediction was inaccurate, wherein the network node is configured to assume that the prediction was accurate if the apparatus does not send the network node an indication that the prediction was inaccurate within a certain time, and
perform a beam switch from a first beam at a time interval t to a second beam at time interval t+1 based on the prediction if the prediction is accurate.
